(19) United States
(12) Patent Application Publication
(10) Pub. No.: US 2014/0013240 A1
(43) Pub. Date: Jan. 9, 2014

(54) CREATING SOCIAL GROUP EVENTS

(71) Applicant: Jaikumar Ganesh, San Francisco, CA (US)

(72) Inventor: Jaikumar Ganesh, San Francisco, CA (US)

(73) Assignee: Google Inc., Mountain View, CA (US)

(21) Appl. No.: 13/541,458

(22) Filed: Jul. 3, 2012

(51) Int. Cl. G06F 15/16; G06F 3/01

(52) U.S. Cl. 715/753

(57) ABSTRACT

Systems and methods for creating a social group event are provided. User interactions corresponding to two users are received and at least one common interest between the two users is identified from the received user interactions. A determination is made as to whether there is a relationship between the two users. When it is determined that there is a relationship, a social group event is suggested for the two users based on the identified at least one common interest with at least one of a specified time or a specified location based on the received user interactions.

### BACKGROUND

Electronic invites may be used to organize social group events between individuals who have common interests. Electronic invites may be created by a host user who determines a time and a location of the social group event, and sends the information out to invitee individuals whom the host believes may be interested in the event. In doing so, the host may either make a determination of appropriate invitees to invite, or the host may send out a mass invite to a contact group.

### SUMMARY

The present disclosure generally relates to creating social group events, and, in particular, to creating social group events based on user interactions on external web-based sources.

The disclosed subject matter relates to a machine-implemented method for creating a social group event. User interactions corresponding to two users are received and at least one common interest between the two users is identified from the received user interactions. A determination is made as to whether there is a relationship between the two users. When it is determined that there is a relationship, a social group event is suggested for the two users based on the identified at least one common interest with at least one of a specified time or a specified location based on the received user interactions.

These and other aspects can include one or more of the following features. The user interactions corresponding to the two users is received from one or more web-based sources, and may correspond to a user interacting with at least one of a calendar or a device location service. The specified time of the social group event may be determined based on the calendar, and the specified location of the social group event may be determined based on the device location service.

In some aspects, a history of responses to suggestions of social group events corresponding to the two users may be retrieved, and the social group event suggested for the two users is further based on the retrieved history of responses. When the history includes a number of negative responses to the suggestions of social group events for the two users greater than a predetermined threshold amount, a social group event for the two users is not suggested for the two users.

The identification of the at least one common interest between the two users includes: (i) extracting a first set of key terms from a first set of user interactions received from a first user of the two users; (ii) extracting a second set of key terms from a second set of user interactions received from a second user of the two users; (iii) comparing the first set of key terms to the second set of key terms; (iv) determining commonalities between the first set of key terms and second set of key terms; and (v) identifying the at least one common interest between the two users based on the determined commonalities.

In some aspects, the determined commonalities between the first and second sets of key terms relate to an event, and the specified time is based on a time corresponding to the event. Furthermore, whether there is a relationship between the two users is determined based on a level of relationship between the two users defined in a social networking service. The level of relationship may be determined based on at least one of a number of contacts shared between the two users or a defined characteristic of the relationship between the two users.

The disclosed subject matter also relates to a machine-readable medium comprising instructions stored therein, which when executed by a system, cause the system to perform operations comprising receiving a request for participation in a social group event, where the request corresponds to a first user and includes at least one event interest. At least a second user with an existing relationship with the first user is identified. A future social event including the at least one event interest corresponding to the received request for which the second user is a participant is identified, and an invitation to the identified future social event is provided to the first user.

These and other aspects can include one or more of the following features. User interactions corresponding to the second user are received, and the future social event is identified based on the received user interactions corresponding to the second user. Identifying the future social event including the at least one event interest includes: (i) extracting a first set of key terms from the request for participation in a social group event; (ii) extracting a second set of key terms from the received user interactions corresponding to the second user; (iii) determining commonalities between the first and second sets of key terms; and (iv) identifying the future social event including the at least one event interest based on the determined commonalities.

In some aspects, the received user interactions corresponding to the second user is received from at least one web-based source. The web-based source includes at least one of a social networking service, a search engine, a blog, a calendar, a messaging service, an electronic payment service, or a device location service. Different weights may be assigned to each of the at least one web-based source, and the received user interactions on which the identification of the future social event is based are weighted based on the web-based source from which the user interactions are received.

In some aspects, identifying the at least second user with the existing relationship with the first user the including identifying a level of relationship between the first and second users based on relationships defined in a social networking service. The level of relationship is determined based on at least one of a number of contacts shared between the first and second users, or a defined characteristic of the relationship between the first and second users.

According to various aspects of the subject technology, a system for creating a social group event is provided. The system includes one or more processors and a machine-readable medium comprising instructions stored therein, which when executed by the processors, cause the processors to perform operations comprising receiving user interactions corresponding to two users. At least one common interest between the two users is identified from the received user interactions. A level of relationship is determined between the two users. When the level of relationship satisfies a predetermined threshold, a social group event is suggested for the two users based on the identified at least one common interest with at least one of a specified time or a specified location based on the received user interactions.

These and other aspects can include one or more of the following features. At least one additional user with the at least one common interest is identified, where the additional user has a level of relationship with at least one of the two users satisfying the predetermined threshold. The additional user may be invited to the suggested social group event.

In some aspects, identifying the common interest between the two users includes: (i) extracting a first set of key terms from a first set of user interactions received from a first user of the two users; (ii) extracting a second set of key terms from a second set of user interactions received from a second user of the two users; (iii) comparing the first set of key terms to the second set of key terms; (iv) determining commonalities between the first and second sets of key terms; and (v) identifying the at least one common interest between the two users based on the determined commonalities.

Furthermore, a history of responses to suggestions of social group events corresponding to the two users may be retrieved, and the social group event suggested for the two users is further based on the retrieved history of responses. Additionally, the level of relationship may be determined based on at least one of a number of contacts shared between the two users, or a defined characteristic of the relationship between the two users.

These and other aspects may provide one or more of the following advantages. Social group events may be automatically suggested based on user interactions with web-based sources such as a social networking service, a search engine, a blog, a calendar, a messaging service, an electronic payment service, or a device location service. By providing a suggested social group event to users that are determined to be socially connected with one another, the individual users may be relieved of the duty of determining a time and locale for the event, as well as the individuals to invite.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates an example network environment which provides for creating social group events.

FIG. 2 illustrates an example of a server system for creating social group events.

FIG. 3 illustrates an example method for creating a social group event based on user interactions.

FIG. 4 illustrates an example method for creating a social group event based on a user request.

FIGS. 5a and 5b provide example user interfaces for creating a social group event based on user interactions.

FIG. 6 conceptually illustrates an example electronic system with which some implementations of the subject technology are implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, structures and components are shown in block diagram form in order to avoid obscuring the concepts of the subject technology.

The disclosed subject matter relates to a machine-implemented method for creating a social group event. User interactions corresponding to two users are received and at least one common interest between the two users is identified from the received user interactions. A determination is made as to whether there is a relationship between the two users. When it is determined that there is a relationship, a social group event is suggested for the two users based on the identified at least one common interest with at least one of a specified time or a specified location based on the received user interactions.

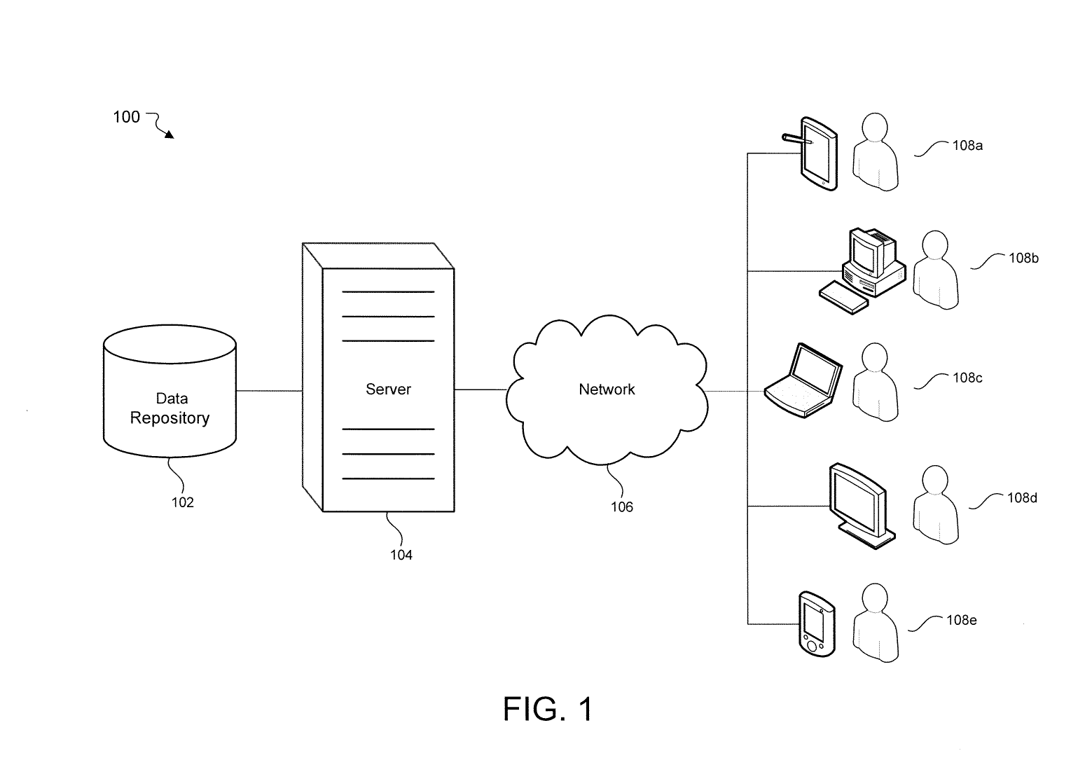

FIG. 1 illustrates an example network environment which provides for creating an electronic invitation for an event. Network environment 100 includes a data repository 102 (e.g., computer-readable storage media) for storing a variety of data accessed by web-based applications. While the network environment 100 includes a single data repository 102 in FIG. 1, the network environment may include additional data repository in some implementations. Data repository 102 may host a variety of data such as data related to social media webpages.

The network environment 100 further includes server 104. While the network environment 100 includes a single server in FIG. 1, the network environment may include several interconnected servers in some implementations. Server 104 may receive requests from user-operated client devices 108a-108e. Server 104 and client devices 108a-108e may be communicatively coupled through a network 106. In some implementations, client devices 108a-108e may request data from server 104. Upon receiving the request, server 104 may retrieve a set of data from data repository 102 and serve the set of information to client devices 108a-108e.

Each of client devices 108a-108e can represent various forms of processing devices. Example processing devices can include a desktop computer, a laptop computer, a handheld computer, a television with one or more processors embedded or coupled thereto, a personal digital assistant (PDA), a cellular telephone, a network appliance, a camera, a smart phone, an enhanced general packet radio service (EGPRS) mobile phone, a media player, a navigation device, an email device, a game console, or a combination of any these data processing devices or other data processing devices. Each of client devices 108a-108e may be any machine configured to generate and transmit a signal that includes location information (e.g., GPS coordinates) to server 104. In some aspects, client devices 108a-108e may include one or more client applications (e.g., mapping applications, GPS applications, or other processes) configured to generate and transmit GPS signals to a server. The GPS signals may include GPS coordinates (e.g., longitude and latitude coordinates) and, in some cases, a time stamp indicating when the GPS signal was generated.

In some aspects, client devices 108a-108e may communicate wirelessly through a communication interface (not shown), which may include digital signal processing circuitry where necessary. The communication interface may provide for communications under various modes or protocols, such as Global System for Mobile communication (GSM) voice calls, Short Message Service (SMS), Enhanced Messaging Service (EMS), or Multimedia Messaging Service (MMS) messaging, Code Division Multiple Access (CDMA), Time Division Multiple Access (TDMA), Personal Digital Cellular (PDC), Wideband Code Division Multiple Access (WCDMA), CDMA2000, or General Packet Radio System (GPRS), among others. For example, the communication may occur through a radio-frequency transceiver (not shown). In addition, short-range communication may occur, such as using a Bluetooth, WiFi, or other such transceiver.

In some aspects, network environment 100 can be a distributed client/server system that spans one or more networks such as network 106. Network 106 can be a large computer network, such as a local area network (LAN), wide area network (WAN), the Internet, a cellular network, or a combination thereof connecting any number of mobile clients, fixed clients, and servers. In some aspects, each client (e.g., client devices 108a-108e) can communicate with servers 104 via a virtual private network (VPN), Secure Shell (SSH) tunnel, or other secure network connection. In some aspects, network 106 may further include a corporate network (e.g., intranet) and one or more wireless access points.

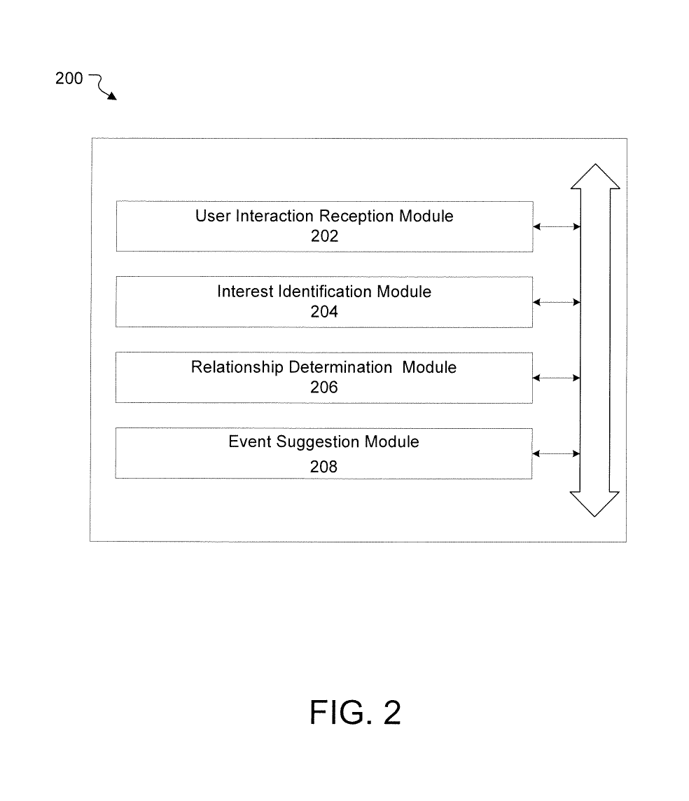

FIG. 2 illustrates an example of a system for creating an electronic invitation for an event. System 200 includes user interaction reception module 202, interest identification module 204, relationship determination module 206, and event suggestion module 208. These modules, which are in communication with one another, process information retrieved from data repository 102 in order to create an electronic invitation for an event. For example, user interactions corresponding to two or more users are received by signal reception module 202. The user interactions may correspond to a user interacting with a social networking service, a search engine, a blog, a calendar, a messaging service, an electronic payment service, or a device location service. Interest identification module 204 identifies, from the received user interactions whether a common interest exists between the two or more users. Once a common interest has been identified, relationship determination module 206 determines whether or not the two or more users have an established relationship. When a relationship is determined to have been established between the two or more users, event suggestion module 208 automatically suggests an event.

In some aspects, the modules may be implemented in software (e.g., subroutines and code). The software implementation of the modules may operate on web browsers running on client devices 108a-108e. In some aspects, some or all of the modules may be implemented in hardware (e.g., an Application Specific Integrated Circuit (ASIC), a Field Programmable Gate Array (FPGA), a Programmable Logic Device (PLD), a controller, a state machine, gated logic, discrete hardware components, or any other suitable devices) and/or a combination of both. Additional features and functions of these modules according to various aspects of the subject technology are further described in the present disclosure.

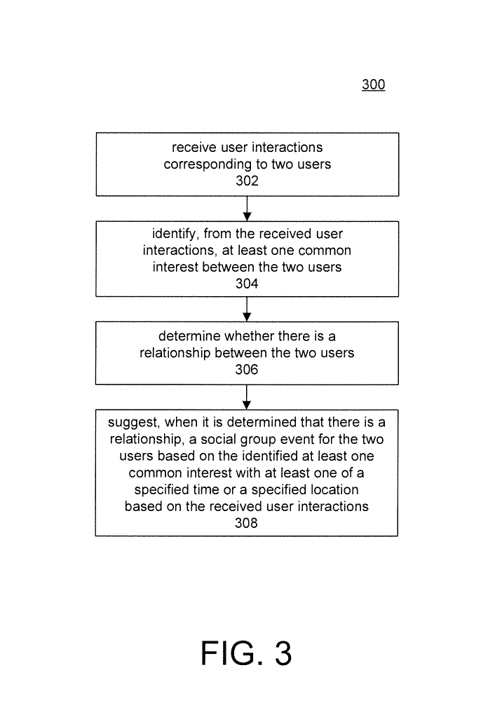

FIG. 3 illustrates example method 300 for creating a social group event based on user interactions. User interactions corresponding to two users are received in 302. At least one common interest between the two users is identified from the received user interactions in 304. For example, two user may individually indicate through interactions with social networking services or blogs that they are interested in watching a same sporting event. A determination of whether there is a relationship between the two users is made in 306 (e.g., a determination is made as to whether or not the two users are socially connected to one another on a social networking service). A social group event based on the identified at least one common interest is suggested for the two users when a relationship is determined to exist in 308. The suggested social group event may include at least one of a specified time or a specified place based on the received user interactions.

While example method 300 describes suggesting a social group event for two users based on the received signals, the suggestions of the social group event may be provided to several users. For example an interest may determined to be common among multiple users that are socially connected to one another. As such, a social group event for multiple invitees may be suggested based on the collective signals received corresponding to the multiple users.

In some implementations, the user interactions corresponding to the two users may be received from external web-based sources such as social networking services. For example, a social networking service webpage may provide information such as a level (e.g., numbers of degrees of separation) or a characteristic (e.g., family members, friends, acquaintances, coworkers, etc.) of a relationship between two users. The more closely related two users are determined to be, the more likely a social group event will be created for the two users. Additionally, user interactions may be received from social networking microblogs (i.e., public posting by users on a social networking service). The content in microblogs may be utilized to determine particular interests of users. For example, a user may post an entry such as “Go Yankees!” From this posting, a determination may be made that the user is a fan of the Yankees and may be interested in watching an upcoming game with friends.

User interactions corresponding to search engines, blogs, calendars, messaging services, electronic payment services, or a device location services may also be used to determine interests of a user. For example, if a user posts a blog entry discussing an upcoming concert at a local venue, a determination may be made that user is interested in attending the concert. Additional determinations such as whether or not the user is available on the date of the concert may be derived from the user's interaction with a calendar. Furthermore, a user's location may be determined based on interactions with a device location service.

In some implementations, mobile device related signals from a variety of mobile device applications may be considered. For example, a mobile device application may provide a signal indicating a user's preferred sports team (e.g., from a sports network application that allows a user to specify favorite teams), establishments that the user frequents (e.g., from an application that allows the user to make reservations at business establishments such as restaurants), or a current location of the user (e.g., from a mapping application). Signals provided from these applications may used to determine whether a suggestion of a social group activity should be made and if so, corresponding time and location for the social activity.

Location information of the users may also be utilized when creating a social group event. For example, a suggestion of a social group event may be based on the location of the two users. A social group event may only be suggested when the two users are local to one another (e.g., within reasonable commuting distance from one another). Furthermore, the specified place of the social group event may be determined based on the location two users. In some aspects, a venue located within a certain distance from the two users may be specified as the location. Alternatively, a venue that is closest to the middle point of the two users may be specified as the location. In some aspects, the venue is suggested based on the determined interest of the two users. For example, if the two users are determined to be interested in watching the Super Bowl, a suggestion of a sports bar as the venue will be more appropriate than a suggestion of a café.

In some aspects, a settings function may be provided to a user for selecting the external web-based sources which the user would like to have considered for suggesting social group events. For example, if a user prefers to not have any user interactions with a messaging service be taken into account for suggesting social group events, the user may adjust the settings accordingly and opt out of that particular feature. When a particular feature is turned off, the interest of a user may be determined based on the remaining features that the user has not opted out of.

In some implementations, different weights may be assigned to factors considered in making suggestions of the social group event. The weights may be modified to indicate an increased or decreased contribution of a corresponding factor. For example, a first weight corresponding to a messaging service may be modified to indicate an increased contribution of user interactions in the messaging service to making suggestions of the social group event, while a second weight corresponding to a social networking service may be modified to indicate a decreased contribution of user interactions to the social networking service in making suggestions of the social group event. In some aspects, the user may assign specific weights to the different factors that contribute to making suggestions of social group events. By providing an adjustable weighting system, the suggestions of social group events may be tailored to suit the user's preference.

In some implementations, a historical record of responses to the suggested social group events received from the user may be maintained. The historical record of responses may be utilized as an additional factor that contributes to the suggestions of future social group events. For example, if a user who has received several suggestions for a happy hour with coworkers has historically declined the suggested invite, then future suggestions of happy hours with coworker may not be made to the user. Conversely, if the user accepts a number of suggestions to attend a ballgame, then future suggestions of ballgames may be made to the user. In some aspects, the historical record may be kept for a predetermined period. Thus, certain suggestions of social group events that may otherwise have been omitted based on historical records may be reintroduced to a user once the predetermined time has elapsed.

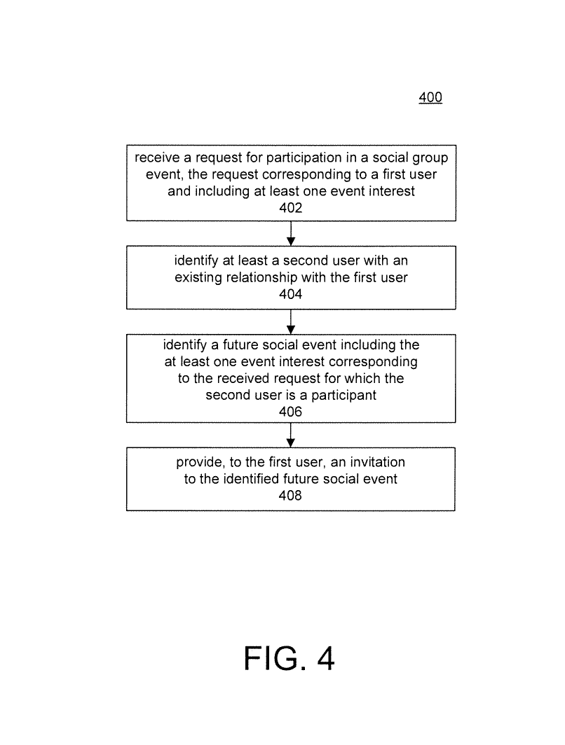

In some implementations, a user may indicate an interest in attending a social group event (e.g., a first user may indicate an interest in watching the Super Bowl). FIG. 4 illustrates example method 400 for creating a social group event based on a user request. A request for participation in a social group event is received in 402. The request corresponds to a first user and includes at least one event interest. The event interest may include such events as sporting competitions (e.g., football games, basketball games, baseball games, etc.), social gatherings (e.g., parties, happy hours, etc.), social events (e.g., concerts, dinners, movies, plays, etc.). At least a second user with an existing relationship with the first user is identified in 404. For example, individuals socially connected to the first user on a social networking service are identified as having existing relationships with the first user.

A future social group event including at least one event interest corresponding to the received request for which the second user is a participant is identified in 406. The future social group event may include an event hosted by the second user or an event to which the second user has been invited. For example, if the second user is hosting a Super Bowl party and the second user is determined to be socially connected to the first user, then the system can suggest the Super Bowl party hosted by the second user to the first user in response to first user's indication of interest in watching the Super Bowl. An invitation to the identified future social group event is provided to the first user in 408.

In some implementations, the user may modify certain settings on which the suggestions may be based. The settings may include characteristics such as distance of event from user, degree of relationship with host/attendees of the event, date and time of the social event, number of attendees of the event, venue of the event, etc. For example, the user may only want to receive suggestions for events that are held within a 10 mile radius and include at least three individuals that are acquaintances/friends of the user. By modifying the different control settings, the user may control the types of suggestions that are made. In this example, any event that falls outside of these criteria will not be suggested to the user.

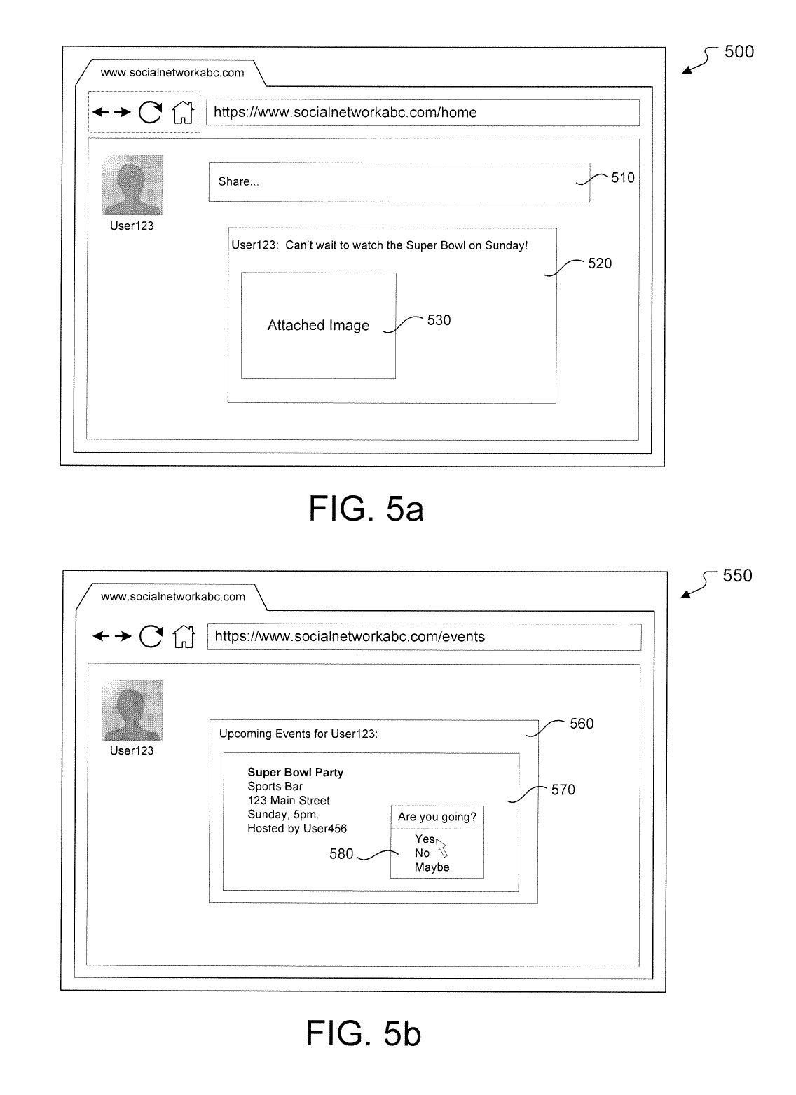

FIGS. 5a and 5b provide example user interfaces for creating a social group event based on user interactions. FIG. 5a provides an example illustration of a social networking service profile page 500 of User123. Profile page 500 shows an entry that had been previously entered in entry field 510 posted as microblog entry 520. Microblog entry 520 may include attached image 530. In some aspects, microblog entry 520 may also include hyperlinks. When one or more microblog entries have been made, the content in the one or more microblog entries may be utilized to determine particular interests of a user. In this example, microblog entry 520, which states “Can't wait to watch the Super Bowl on Sunday!”, may be utilized to determine that User123 is interested in watching the Super Bowl. Thus, a social group event may be suggested for User123.

FIG. 5b provides an example illustration of a social networking service events page 550. Events page 550 may include upcoming events window 560, which shows social group event 570 has been suggested to User123. In this example, User123 has been invited to a Super Bowl party hosted by User456 at Sports Bar on 123 Main Street. Social group event 570 may be suggested for User123 based on User123's microblog entry 520. Suggested social group event 570 may also include response box 580. Response box 580 provides a means from which User123 may respond to suggested social group event 570.

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some implementations, multiple software aspects of the subject disclosure can be implemented as sub-parts of a larger program while remaining distinct software aspects of the subject disclosure. In some implementations, multiple software aspects can also be implemented as separate programs. Finally, any combination of separate programs that together implement a software aspect described here is within the scope of the subject disclosure. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

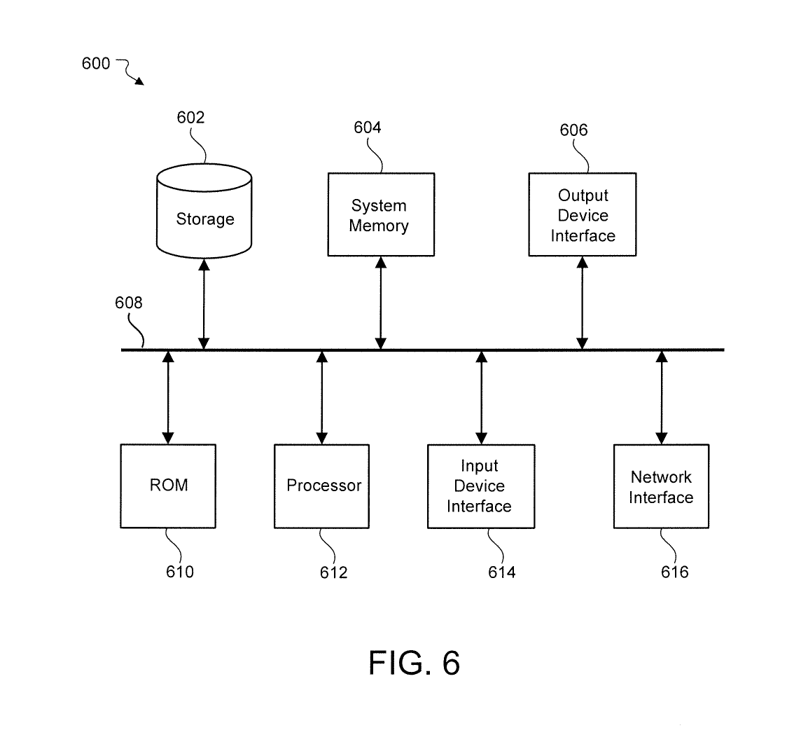

FIG. 6 conceptually illustrates an example electronic system 600 with which some implementations of the subject technology are implemented. Electronic system 600 can be a computer, phone, PDA, or any other sort of electronic device. Such an electronic system includes various types of computer readable media and interfaces for various other types of computer readable media. Electronic system 600 includes a bus 608, processing unit(s) 612, a system memory 604, a read-only memory (ROM) 610, a permanent storage device 602, an input device interface 614, an output device interface 606, and a network interface 616.

Bus 608 collectively represents all system, peripheral, and chipset buses that communicatively connect the numerous internal devices of electronic system 600. For instance, bus 608 communicatively connects processing unit(s) 612 with ROM 610, system memory 604, and permanent storage device 602.

From these various memory units, processing unit(s) 612 retrieves instructions to execute and data to process in order to execute the processes of the subject disclosure. The processing unit(s) can be a single processor or a multi-core processor in different implementations.

ROM 610 stores static data and instructions that are needed by processing unit(s) 612 and other modules of the electronic system. Permanent storage device 602, on the other hand, is a read-and-write memory device. This device is a non-volatile memory unit that stores instructions and data even when electronic system 600 is off. Some implementations of the subject disclosure use a mass-storage device (such as a magnetic or optical disk and its corresponding disk drive) as permanent storage device 602.

Other implementations use a removable storage device (such as a floppy disk, flash drive, and its corresponding disk drive) as permanent storage device 602. Like permanent storage device 602, system memory 604 is a read-and-write memory device. However, unlike storage device 602, system memory 604 is a volatile read-and-write memory, such as random access memory. System memory 604 stores some of the instructions and data that the processor needs at runtime. In some implementations, the processes of the subject disclosure are stored in system memory 604, permanent storage device 602, and/or ROM 610. For example, the various memory units include instructions for creating a social group event based on a user request in accordance with some implementations. From these various memory units, processing unit(s) 612 retrieves instructions to execute and data to process in order to execute the processes of some implementations.

Bus 608 also connects to input and output device interfaces 614 and 606. Input device interface 614 enables the user to communicate information and select commands to the electronic system. Input devices used with input device interface 614 include, for example, alphanumeric keyboards and pointing devices (also called “cursor control devices”). Output device interface 606 enables, for example, the display of images generated by the electronic system 600. Output devices used with output device interface 606 include, for example, printers and display devices, such as cathode ray tubes (CRT) or liquid crystal displays (LCD). Some implementations include devices such as a touchscreen that functions as both input and output devices.

Finally, as shown in FIG. 6, bus 608 also couples electronic system 600 to a network (not shown) through a network interface 616. In this manner, the computer can be a part of a network of computers, such as a local area network, a wide area network, or an Intranet, or a network of networks, such as the Internet. Any or all components of electronic system 600 can be used in conjunction with the subject disclosure.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network and a wide area network, an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

All structural and functional equivalents to the elements of the various aspects described throughout this disclosure that are known or later come to be known to those of ordinary skill in the art are expressly incorporated herein by reference and are intended to be encompassed by the claims.

What is claimed is:

1. A computer-implemented method comprising:
receiving user interactions corresponding to two users;
identifying, from the received user interactions, at least one common interest between the two users;
determining whether there is a relationship between the two users; and
suggesting, when it is determined that there is a relationship, a social group event for the two users based on the identified at least one common interest with at least one of a specified time or a specified location based on the received user interactions.

2. The computer-implemented method of claim 1, wherein the user interactions correspond to a user interacting with at least one of a calendar or a device location service, and wherein the specified time of the social group event is determined based on the calendar, and the specified location of the social group event is determined based on the device location service.

3. The computer-implemented method of claim 1, further comprising retrieving a history of responses to suggestions of social group events corresponding to the two users, wherein suggesting the social group event for the two users is further based on the retrieved history of responses.

4. The computer-implemented method of claim 3, wherein when the history includes a number of negative responses to the suggestions of social group events for the two users greater than a predetermined threshold amount, a social group event for the two users is not suggested for the two users.

5. The computer-implemented method of claim 1, wherein identifying the at least one common interest between the two users comprises:
extracting a first set of key terms from a first set of user interactions received from a first user of the two users;
extracting a second set of key terms from a second set of user interactions received from a second user of the two users;
comparing the first set of key terms to the second set of key terms;
determining commonalities between the first set of key terms and second set of key terms; and
identifying the at least one common interest between the two users based on the determined commonalities.

6. The computer-implemented method of claim 5, wherein the determined commonalities between the first and second sets of key terms relate to an event, and wherein the specified time is based on a time corresponding to the event.

7. The computer-implemented method of claim 1, wherein determining whether there is a relationship between the two users comprises determining a level of relationship between the two users based on relationships defined in a social networking service.

8. The computer-implemented method of claim 7, wherein the level of relationship is determined based on at least one of a number of contacts shared between the two users, or a defined characteristic of the relationship between the two users.

9. A machine-readable medium comprising instructions stored therein, which when executed by a system, cause the system to perform operations comprising:
receiving a request for participation in a social group event, the request corresponding to a first user and including at least one event interest;
identifying at least a second user with an existing relationship with the first user;
identifying a future social event including the at least one event interest corresponding to the received request for which the second user is a participant; and
providing, to the first user, an invitation to the identified future social event.

10. The machine-readable medium of claim 9, further comprising instructions for receiving user interactions corresponding to the second user, wherein the future social event is identified based on the received user interactions corresponding to the second user.

11. The machine-readable medium of claim 10, wherein identifying the future social event including the at least one event interest comprises:
extracting a first set of key terms from the request for participation in a social group event;
extracting a second set of key terms from the received user interactions corresponding to the second user;
determining commonalities between the first and second sets of key terms; and
identifying the future social event including the at least one event interest based on the determined commonalities.

12. The machine-readable medium of claim 10, wherein the received user interactions corresponding to the second user is received from at least one web-based source, the at least one web-based source comprising at least one of a social networking service, a search engine, a blog, a calendar, a messaging service, an electronic payment service, or a device location service.

13. The machine-readable medium of claim 12, wherein different weights are assigned to each of the at least one web-based source, and wherein the received user interactions on which the identification of the future social event is based are weighted based on the web-based source from which the user interactions are received.

14. The machine-readable medium of claim 9, wherein identifying the at least second user with the existing relationship with the first user comprises identifying a level of relationship between the first and second users based on relationships defined in a social networking service.

15. The machine-readable medium of claim 14, wherein the level of relationship is determined based on at least one of a number of contacts shared between the first and second users, or a defined characteristic of the relationship between the first and second users.

16. A system comprising:
one or more processors; and
a machine-readable medium comprising instructions stored therein, which when executed by the processors, cause the processors to perform operations comprising:
receiving user interactions corresponding to two users;
identifying, from the received sets of signals, at least one common interest between the two users;
determining a level of relationship between the two users; and
suggesting, for the two users having a level of relationship satisfies a predetermined threshold, a social group event based on the identified at least one common interest with at least one of a specified time or a specified location based on the received user interactions.

17. The system of claim 16, further comprising instructions for:
identifying at least one additional user with the at least one common interest, wherein the at least one additional user has a level of relationship with at least one of the two users satisfying the predetermined threshold; and
inviting the at least one additional user to the suggested social group event.

18. The system of claim 16, wherein identifying the at least one common interest between the two users comprises:
extracting a first set of key terms from a first set of user interactions received from a first user of the two users;
extracting a second set of key terms from a second set of user interactions received from a second user of the two users;
comparing the first set of key terms to the second set of key terms;
determining commonalities between the first and second sets of key terms; and
identifying the at least one common interest between the two users based on the determined commonalities.

19. The system of claim 16, further comprising instructions for retrieving a history of responses to suggestions of social group events corresponding to the two users, wherein suggesting the social group event for the two users is further based on the retrieved history of responses.

20. The system of claim 16, wherein the level of relationship is determined based on at least one of a number of contacts shared between the two users, or a defined characteristic of the relationship between the two users.
